(19) United States
(12) Patent Application Publication
(10) Pub. No.: US 2026/0039661 A1
(43) Pub. Date: Feb. 5, 2026

(54) Distributed Storage and Authentication System

(71) Applicants: Metatope LLC, Woodland Hills, CA (US); CPI Technologies GmbH, Frankfurt am Main (DE)

(72) Inventors: Jordan Yallen, Los Angeles, CA (US); Joseph Poulose, Chatsworth, CA (US); Maximilian Schmidt, Frankfurt (DE); Walker Holmes, Indialantic, FL (US)

(73) Assignees: Metatope LLC, Woodland Hills, CA (US); CPI Technologies GmbH, Frankfurt am Mainn (DE)

(21) Appl. No.: 19/287,249

(22) Filed: Jul. 31, 2025

Related U.S. Application Data
(60) Provisional application No. 63/677,729, filed on Jul. 31, 2024.

(51) Int. Cl. H04L 9/40

(52) U.S. Cl. CPC H04L 63/10

(57) ABSTRACT

An authorized computing device receives indications of data actions taken end users on a user platform. Each data action is selected from a group comprising an edit action, a create action, or a delete action. The authorized computing device collects the data actions to form a batch of data actions. The batch of data actions include data actions that have occurred within a range of time. The authorized computing device generates a Merkle tree corresponding to the batch of data actions. Each leaf of the Merkle tree is associated with a respective data action in the batch of data actions. The authorized computing device published a root node of the Merkle tree to a smart contract associated with the user platform on a blockchain. The root node of the Merkle tree is used to verify individual data actions in the batch of data actions.

### CROSS-REFERENCE TO RELATED APPLICATIONS

This application claims priority to U.S. Provisional Application No. 63/677,729, filed Jul. 31, 2024, which is hereby incorporated by reference in its entirety.

### FIELD OF THE DISCLOSURE

Embodiments disclosed herein generally related to a distributed storage and authentication system.

### BACKGROUND

Social media platforms provide end users with the ability to create and post their original content in the form of images, video, text, and the like. End users are able to engage with other users and their posts through comments, likes, and shares. Through social media, individuals and organizations have expanded their reach to end users both domestically and internationally.

### SUMMARY

In some embodiments, a method is disclosed herein. An authorized computing device receives indications of data actions taken by end users on a user platform. Each data action is selected from a group comprising an edit action, a create action, or a delete action. The authorized computing device collects the data actions to form a batch of data actions. The batch of data actions includes data actions that have occurred within a range of time. The authorized computing device generates a Merkle tree corresponding to the batch of data actions. Each leaf of the Merkle tree is associated with a respective data action in the batch of data actions. The authorized computing device publishes a root node of the Merkle tree to a smart contract associated with the user platform on a blockchain. The root node of the Merkle tree is used to verify individual data actions in the batch of data actions.

In some embodiments, a non-transitory computer readable medium is disclosed herein. The non-transitory computer readable medium includes one or more sequences of instructions, which, when executed by a processor, causes an authorized computing device to perform operations. The operations include receiving, by the authorized computing device, indications of data actions taken end users on a social media platform. Each data action is selected from a group comprising an edit action, a create action, or a delete action. The operations further include collecting, by the authorized computing device, the data actions to form a batch of data actions. The batch of data actions includes data actions that have occurred within a range of time. The operations further include generating, by the authorized computing device, a Merkle tree corresponding to the batch of data actions. Each leaf of the Merkle tree is associated with a respective data action in the batch of data actions. The operations further include publishing, by the authorized computing device, a root node of the Merkle tree to a smart contract associated with the social media platform on a blockchain. The root node of the Merkle tree is used to verify individual data actions in the batch of data actions.

In some embodiments, a system is disclosed herein. The system includes an authorized computing device in communication with end user devices and other authorized computing devices. The authorized computing device includes a processor and a memory. The memory has programming instructions stored thereon, which, when executed by the processor, causes the system to perform operations. The operations include receiving, by the authorized computing device, indications of data actions taken end users on a social media platform. Each data action is selected from a group comprising an edit action, a create action, or a delete action. The operations further include collecting, by the authorized computing device, the data actions to form a batch of data actions. The batch of data actions includes data actions that have occurred within a range of time. The operations further include generating, by the authorized computing device, a Merkle tree corresponding to the batch of data actions. Each leaf of the Merkle tree is associated with a respective data action in the batch of data actions. The operations further include publishing, by the authorized computing device, a root node of the Merkle tree to a smart contract associated with the social media platform on a blockchain. The root node of the Merkle tree is used to verify individual data actions in the batch of data actions.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computing environment, according to one exemplary embodiment.

FIG. 2 is a block diagram illustrating the computing environment of FIG. 1 in more detail, according to one exemplary embodiment.

FIG. 3 is a block diagram illustrating structure of a database, according to example embodiments.

FIG. 4 is a flow diagram illustrating a workflow for initiating and synchronizing a compute node on an authorized user device, according to example embodiments.

FIG. 5 is a flow diagram illustrating a workflow for a data manipulation process for data hosted on application platform, according to example embodiments.

FIG. 6A illustrates a system bus computing system architecture, according to example embodiments.

FIG. 6B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

As those skilled in the art understand, social media, for example, has become a critical component for companies and individuals to build and/or maintain their brand. Through social media, companies and individuals have the ability to engage with customers, potential customers, partners, potential partners, and followers throughout the world. Because of this maintaining or verifying the authenticity of actions on social media is critical for companies and individuals. As technology continues to improve, the prevalence of automated bots and deep fakes across social media platforms is steadily increasing. Accordingly, it has been increasingly more difficult to verify whether certain actions on social media (e.g., posts, comments, likes, shares, etc.) are authentic or modified in any way.

One or more techniques described herein address the above technical limitations of platforms (e.g., social media platforms, advertisement platforms, gaming platforms, etc.) by providing distributed storage and authentication system for verifying activity on the platform. For example, one or more techniques described herein utilize a distributed series of authorized computing nodes that are capable of storing and encrypting data actions that have taken place on the platform. Through such storage and encryption techniques, the authorized computing nodes may create a distributed and immutable record of activities on the platform that may be verified at any point in time.

While the above discussion references social media activities, those skilled in the art understand that the techniques described below are not limited to social network activities and is merely one example. More generally, the below techniques can be used with any database system such as, but not limited to, a social media platform, an advertising platform, a gaming platform, and the like.

The term “user” as used herein includes, for example, a person or entity that owns a computing device or wireless device; a person or entity that operates or utilizes a computing device or wireless device; or a person or entity that is otherwise associated with a computing device or wireless device. It is contemplated that the term “user” is not intended to be limiting and may include various examples beyond those described.

The term “digital content” as used herein includes, for example, audio content (e.g., podcasts, songs, audiobooks, etc.), image content, video content, text content, and/or any combination of one or more of audio content, image content, and video content.

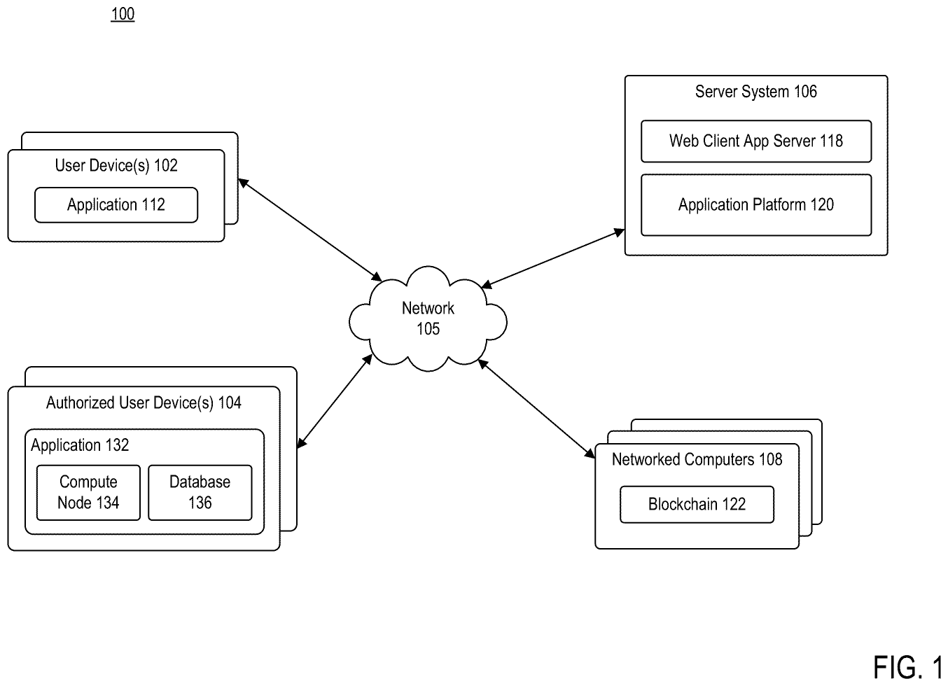

FIG. 1 is a block diagram illustrating computing environment 100, according to one embodiment. Computing environment 100 may include at least one or more user devices 102, one or more authorized user devices 104, a server system 106, and one or more networked computers 108 communicating via network 105.

In some embodiments, computing environment 100 may be representative of a metaverse social network environment, such as that described in U.S. application Ser. No. 18/193,271, now U.S. Pat. No. 11,860,981, which is hereby incorporated by reference in its entirety.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by user. User device 102 may be representative of a mobile device, a tablet, a desktop computer, virtual reality (VR) system, augmented reality (AR) system, extended reality (XR) system, or any computing system having the capabilities described herein. User device 102 may include at least application 112.

Application 112 may be representative of a social media application associated with server system 106. In some embodiments, application 112 may be a standalone application associated with server system 106. In some embodiments, application 112 may be representative of a web-browser configured to communicate with server system 106. In some embodiments, user device 102 may communicate over network 105 to request a webpage, for example, from web client application server 118 of server system 106. For example, user device 102 may be configured to execute application 112 to enter a social media website existing on the metaverse and hosted by web client application server 118. The content that is displayed to user device 102 may be transmitted from web client application server 118 to user device 102, and subsequently processed by application 112 for display through a graphical user interface (GUI) of user device 102.

As those skilled in the art understand, via application 112, user device 102 may perform various actions with respect to an application platform. Generally, a user may create and post digital content and/or interact with digital content created by other users. In some embodiments, users may be able to edit the digital content that they created and/or posted. In some embodiments, users may be able to delete the digital content that they created and/or posted. In some embodiments, interacting with digital content created by other users may include liking (e.g., hearting, favoriting, thumbs-upping, etc.) the digital content, sharing the digital content (e.g. re-tweeting, re-posting, linking, etc.), bookmarking the digital content, commenting on the digital content, and the like. Using a more specific example, via application 112, a user may create digital content with their avatar in a simulated virtual environment, such as a metaverse environment.

Server system 106 may be configured to host an application platform accessible to user devices 102 and authorized user devices 104. For example, server system 106 may include web client application server 118 and application platform 120. Application platform 120 may be configured to host digital content generated by a user and facilitate digital interaction with the digital content. In some embodiments, application platform 120 may be hosted in a simulated virtual environment, such as a metaverse environment, in which users can post images or videos using an avatar that is unique to them.

Authorized user device 104 may be substantially similar to user device 104. User device 104 may be representative of a mobile device, a tablet, a desktop computer, virtual reality (VR) system, augmented reality (AR) system, extended reality (XR) system, or any computing system having the capabilities described herein. Authorized user device 104 may include at least application 132.

Application 132 may be representative of a social media application associated with server system 106. In some embodiments, application 132 may be a standalone application associated with server system 106. In some embodiments, application 132 may be representative of a web-browser configured to communicate with server system 106. In some embodiments, user device 104 may communicate over network 105 to request a webpage, for example, from web client application server 118 of server system 106. For example, user device 104 may be configured to execute application 132 to enter a social media website existing on the metaverse and hosted by web client application server 118. The content that is displayed to user device 104 may be transmitted from web client application server 118 to user device 104, and subsequently processed by application 132 for display through a GUI of user device 104.

As those skilled in the art understand, via application 132, authorized user device 104 may perform various actions with respect to the application platform. Generally, a user may create and post digital content and/or interact with digital content created by other users. In some embodiments, users may be able to edit the digital content that they created and/or posted. In some embodiments, users may be able to delete the digital content that they created and/or posted. In some embodiments, interacting with digital content created by other users may include liking (e.g., hearting, favoriting, thumbs-upping, etc.) the digital content, sharing the digital content (e.g. re-tweeting, re-posting, linking, etc.), bookmarking the digital content, commenting on the digital content, and the like. Using a more specific example, via application 132, a user may create digital content with their avatar in a simulated virtual environment, such as a metaverse environment.

In addition to the functionality described above, authorized user device 104 may include additional privileges or permissions compared to user device 102. For example, authorized user devices 104 may be configured to communicate with each other in an ad hoc peer-to-peer network to notify each authorized user device 104 of any actions that are performed with respect to the application platform 120. In this manner, each authorized user device 104 may be configured to maintain a record of actions that occur on the application platform in a decentralized and distributed manner. In some embodiments, authorized user device 104 may be capable of authenticating the actions that occur on the application platform and broadcasting proof of that authentication on a blockchain environment. In this manner, authorized user devices 104 may create an immutable record of actions on the application platform, any of which may be verified through calls to the blockchain environment.

As shown, application 132 of authorized user device 104 may further include compute node 134 and database 136. Compute node 134 may be configured to process actions performed by end users in application platform 120. For example, in operation, compute node 134 may receive an indication from server system 106 that an end user performed an action on application platform 120. In some embodiments, compute node 134 may be configured to broadcast or communicate the action to other authorized user devices 104 via an ad hoc peer-to-peer network. In some embodiments, compute node 134 may receive an indication from another compute node 134 of another authorized user device 104 that an action occurred on application platform 120. Compute node 134 may store the actions in database 136 and then synchronize database among all authorized user devices 104. In this manner, database 136—that includes a record of actions performed on application platform 120—may be replicated across multiple authorized user devices 104.

In some embodiments, each authorized user device 104 may be permissioned to operate compute node 134. For example, an admin or individual associated with server system 106 may permit authorized user device 104 to execute compute node 134. In some embodiments, authorized user device 104 may be permitted to operate compute node 134 via an on-prem portal

In some embodiments, compute node 134 may be configured to batch process received actions. For example, for a pre-determined number of actions performed on application platform 120, compute node 134 may be configured to generate a Merkle tree representation of the data, where each leaf node of the Merkle tree corresponds to a given action. In some embodiments, to generate a leaf node for a given action, compute node 134 may hash the string corresponding to the action using a private key associated with authorized user device 104. As those skilled in the art understand, the leaf nodes are the lowest level of the Merkle tree—in other words, the lowest level of the Merkle tree represent hashed values corresponding to the actions in a given batch. Starting from the leaf, each node above the leaf is a hash of the label of its child nodes. This process continues until a root node is reached.

As those skilled in the art understand, although the present disclosure focuses on Merkle trees, other computational proofs could also be performed, such as, but not limited to, Verkle trees, hash trees, and the like.

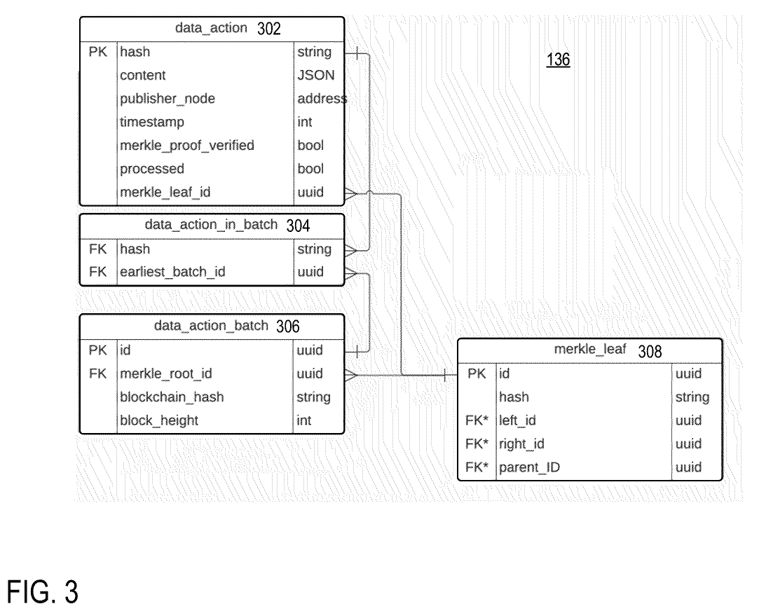

In some embodiments, compute node 134 may store information associated with the Merkle tree in database 136. FIG. 3 is a block diagram illustrating structure of database 136, according to example embodiments. As shown, database 136 may store various information associated with each data action. For example, for each action, compute node 134 may store information associated with the data action (e.g., data_action 302), an indication of the batch that includes the data action (e.g data_action_in_batch 304), information associated with each batch (e.g., data_action_batch 306), and information associated with the leaf corresponding to the data action (e.g., Merkle_leaf 308).

Referring back to FIG. 1, in some embodiments, compute node 134 may publish or broadcast the root node of each data batch to blockchain 122. For example, compute node 134 may publish or broadcast the root node of each data batch to a specific smart contract in blockchain 122. Accordingly, using database 136 and information stored on blockchain 122, compute node 134 may verify the authenticity of a data action that was performed on application platform 120 by using the hash value of the root node from the Merkle tree corresponding to the data action.

In some embodiments, each authorized user device 104, or more specifically, each compute node 134 may be configured to watch or monitor blockchain 122 for new registered data action batches. If, for example, a new data batch action was published to blockchain 122, every compute node 134 will want to download the new data action batch from another compute node 134 through peer-to-peer communication. Once downloaded, each authorized user device 104 may process the data locally.

Networked computers 108 may be configured to host blockchain 122. In some embodiments, blockchain 122 may be a public blockchain. In some embodiments, blockchain 122 may be a private blockchain, such as, for example, a private blockchain associated with server system 106. Generally, blockchain 122 may be representative of any blockchain configured to support non-fungible tokens. For example, blockchain 122 may be a public or private blockchain based on the Ethereum platform. Each authorized user device 104 may have read/write access to blockchain 122.

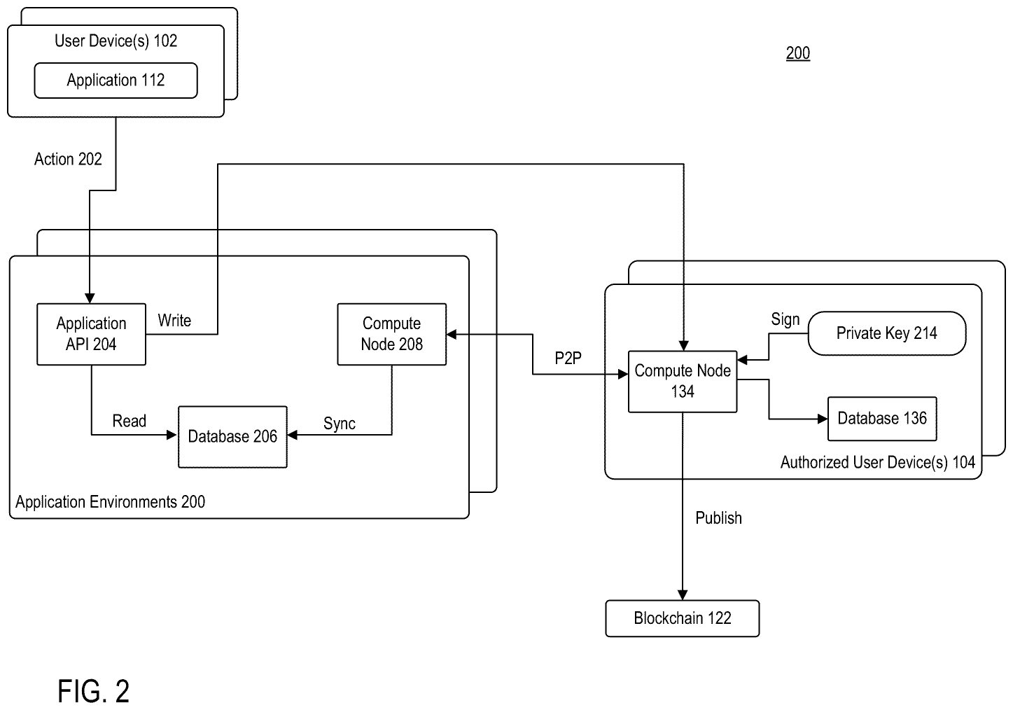

FIG. 2 is a block diagram illustrating computing environment 100 in more detail, according to example embodiments. As shown, user devices 102 and server system 106 may be in communication via network 105. In some embodiments, authorized user devices 102 and server system 106 may be in communication via an ad hoc peer-to-peer network.

In operation, user device 102 may perform a data action (“action 202”) with respect to application platform 120. Action 202 may be communicated to an application environment 200 executing in application platform 120. In some embodiments, action 202 may be communicated to application environment 200 via application programming interface (“API 204”) of application environment 200. In some embodiments, action 202 may be one of a create action, an update action, or a delete action.

In some embodiments, create actions may be in the following format:
{“type”: “create”, “entity”: “(entity name)”, “content”: “(JSON of data)”}
   where type corresponds to the type of action (e.g., create), entity corresponds to a user or account that performed the action, and content corresponds to a JSON representation of the content associated with the action. In some embodiments, update actions may be in the following format:

{“type”: “update”, “entity”: “(entity name)”, “content”: “{\”field1\”: \“new value\”}”,
“filterConditions”: “{\”field1\”: \“current value\”}”}

where type corresponds to the type of action (e.g., update), entity corresponds to a user or account that performed the action, and content corresponds to the content on the application platform, filter conditions may correspond to filters placed on the action. An exemplary filter condition may be, for example, a user attempting to edit only a comment of themselves for a post, but not all comments associated with the post. The filter may ensure that only the correct comment is edited. In some embodiments, multiple entities can be edited with one edit action at the same time if filter conditions apply on multiple entities.

In some embodiments, delete actions may be in the following format:

{“type”: “delete”, “entity”: “(entity name)”, “filterConditions”: “{\”field1\”: \”existing
value\”}”}

where type corresponds to the type of action (e.g., delete), entity corresponds to a user or account that performed the action, and filter conditions may correspond to filters placed on the action. An exemplary filter condition may be, for example, a user attempting to delete only likes from a given user and a post, but not all likes across the application platform. As shown, application environment 200 may include API 204, database 206, and compute node 208. API 204 may be configured to receive or intercept actions from user device 102. For example, in operation, when a user of user device 102 performs an action, such action may be in the form of an API call from application 112 to API 204. Depending on the action type, API 204 may handle action 202 differently. For example, if action 202 is a write action type, API 204 may communicate action 202 to one or more authorized user devices 104. As discussed above in conjunction with FIG. 1, compute node 134 may be configured to process action 202. In some embodiments, compute node 134 may process action 202 instantly in database 136. For example, if action 202 is a create action or a delete action, compute node 134 may immediately process action 202 in database 136. In some embodiments, immediately processing action 202 in database 206 may involve compute node 134 writing a new data action batch corresponding to action 202 using private key 214 and publishing or broadcasting the new data action batch to blockchain 122. Once published, another node 134 may recognize the new data action batch on blockchain 122, download the data action batch from another node 134 or node 208 via peer-to-peer communication, and may verify the data action batch locally in database 136. After successful verification, compute node 134 may apply the data actions to its local database 136. In some embodiments, compute node 134 may create a snapshot of current block height, so that other nodes can download the snapshot for current block via peer-to-peer if necessary. If, for example, action 202 is an edit action, compute node 134 may wait to process action 202 until a threshold number of actions are collected for batch processing.

In some embodiments, compute node 134 may be configured to generate a Merkle tree representation of the data using private key 214, where each leaf node of the Merkle tree corresponds to a given action. In some embodiments, compute node 134 may store information associated with the Merkle tree in database 136. Compute node 134 may broadcast or publish the root of the Merkle tree to blockchain 122.

Compute node 134 may then communicate the updated database information with compute node 208. Compute node 208 may then synchronize the updated database information with local database 206. Local database 206 may maintain all data action information associated with application platform 120.

If, on the other hand, action 202 is a read action, then API 204 may submit a read request to database 206. Database 206 may respond to API 204 with the requested information, which may be relayed from API 204 to user device 102.

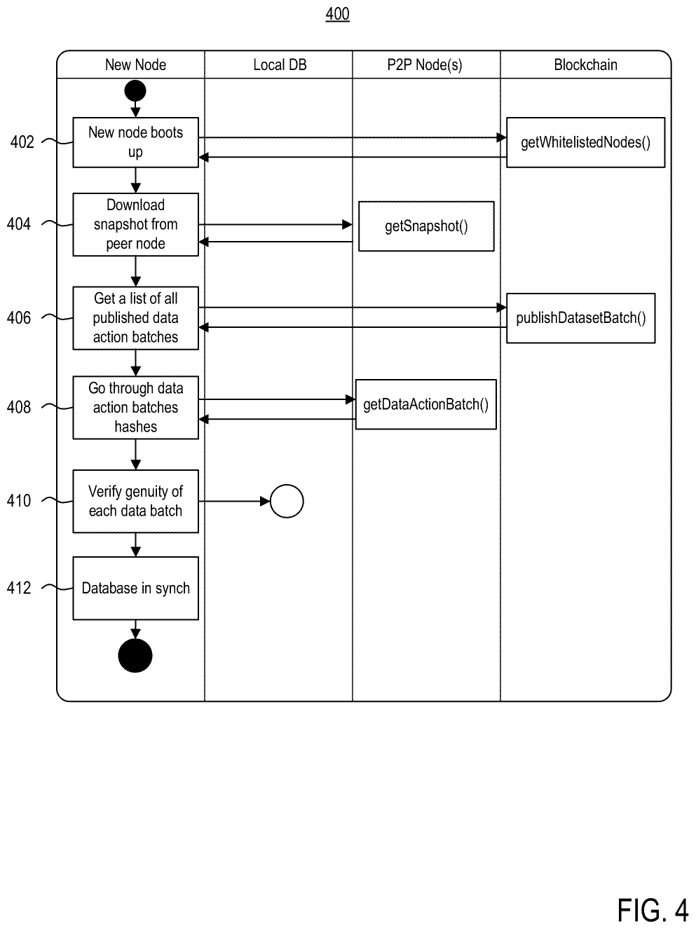

FIG. 4 is a flow diagram illustrating a workflow 400 for initiating and synchronizing a compute node 134 on an authorized user device 104, according to example embodiments. Workflow 400 may begin at step 402.

At step 402, compute node 134 may be initialized. During initialization, compute node 134 may request a list of whitelisted nodes from a smart contract associated with application platform 120 stored on blockchain 122. In some embodiments, the white-listed nodes may be representative of a list of authorized user devices 104.

At step 404, compute node 134 may download a snapshot of data actions from a peer node. For example, compute node 134 may communicate with another compute node executing on another authorized user device over a peer-to-peer network. In some embodiments, the snapshot of data actions may represent a snapshot of the database maintained locally by the other compute node. More generally, a snapshot is an export of the database after processing a given data action batch, which is represented by the BlockID of the block where the data action batch was published on blockchain 122. Other nodes can download snapshots of nodes. This process saves a significant amount of time. For example, imagine there are 1,000,000 data action batches already published. It is much faster to download a snapshot from the highest block height from another node, import the snapshot and only process the remaining action batches which may have occurred in the time while downloading and processing the snapshot compared to all the data action batches.

At step 406, compute node 134 may get or retrieve a list of all published data action batches (e.g., Merkle roots). In some embodiments, compute node 134 may get or retrieve a list of all published data action batches since known block height. For example, compute node 134 may submit a get request to the smart contract associated with application platform stored on blockchain 122.

At step 408, compute node 134 may iterate through each data batch hash chronologically. For example, in operation, compute node 134 may interface with one or more other compute nodes to retrieve data action batches. In some embodiments, if, for example, there are multiple datasets in the same block of blockchain 122, compute node 134 may order the datasets alphabetically by hash and process the datasets in this order.

At step 410, compute node 134 may perform a Merkle proof for each data action to verify each data action. For example, compute node 134 may effectively recreate the Merkle tree process for each data action batch and compare the root node generated during the Merkle tree process to the retrieved Merkle roots from blockchain 122. Ideally, the Merkle tree generated by compute node 134 should yield the same value as the Merkle root stored in blockchain 122. Such data may be stored in database 136.

Once each data batch is processed, at step 412, local database 136 should be synchronized databases of other authorized user devices.

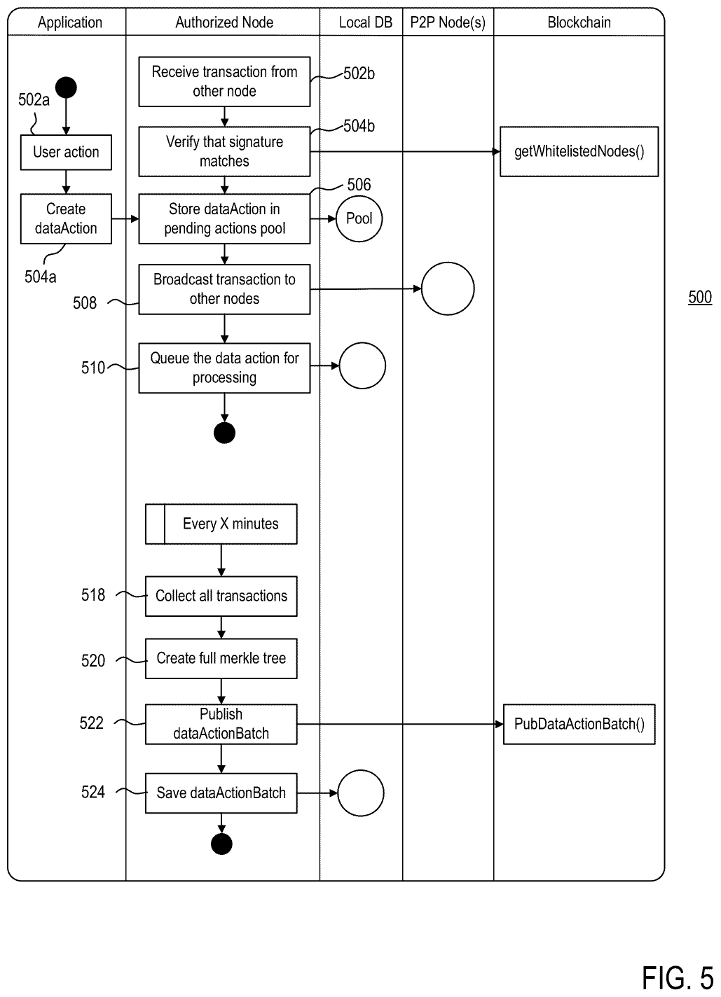

FIG. 5 is a flow diagram illustrating a workflow 500 for a data manipulation process for data hosted on application platform 120, according to example embodiments.

In some embodiments, workflow 500 may begin at step 502a. At step 502a, a user of user device 102 may perform a data action with respect to application platform 120. The data action may be one of a create, edit, or delete data action. At step 504a, application 112 may detect the data action and may broadcast the data action to authorized user devices 104.

In some embodiments, workflow 500 may begin at step 502b. At step 502b, authorized user device 104 may receive an indication of a data action or transaction from another node, such as another authorized user device 104 or server system 106. At step 504b, authorized user device 104 may verify the signature of the authorized user device that sent the indication of the data action or transaction. For example, authorized user device 104 may submit a GET request to blockchain 122 to obtain a list of authorized user devices (e.g., whitelisted nodes). Authorized user device 104 may compare the signature of the authorized user device that sent the indication of the data action or transaction to the list of authorized user devices to ensure that the authorized user device is indeed legitimate.

At step 506, compute node 134 may store the data action in pending actions pool for processing. At step 508, compute node 134 may broadcast the data action to other authorized user devices 104. For example, compute node 134 may communicate with compute nodes of other authorized user devices 104 over an ad hoc peer-to-peer network.

Depending on the type of data action, compute node 134 may prioritize processing differently. For example, at step 510, compute node 134 may queue the data action for processing. In some embodiments, instead of queuing all data actions for processing, compute node 134 may expedite the processing of certain data actions depending on the data action type. For example, if compute node 134 determines that the data action is an edit data action, then compute node 134 may not process the data action instantly and may instead wait to process the data action during batch processing. In another example, if compute node 134 determines that the data action is a create or delete data action, then compute node 134 may process the data action instantly by hashing the data action with private key 214.

After every pre-determined interval (e.g., after every x-minutes), compute node 134 may process a data batch. For example, at step 518, compute node 134 may collect all data actions that have occurred in the last x-minutes. Using the data actions, at step 520, compute node 134 may create a Merkle tree. For example, compute node 134 may generate a plurality of leaf nodes, where each leaf node corresponds to a specific data action. At step 522, compute node 134 may publish the data action batch to the smart contract on blockchain 122. For example, compute node 134 may publish the hash of the root node of the Merkle tree to the smart contract on blockchain 122. At step 524, compute node 134 may save the data action batch (e.g., the full Merkle tree or root node of the Merkle tree) in database 136.

### Advertising Example

As indicated above, in some embodiments, application platform and application environment may be representative of an advertisement platform and advertising environment. As such, the present approach can provide various benefits to each party to an advertisement system. For advertisers, the present approach can be used to ensure planned budgets and expenditures match accurately. For agencies, the present approach can be used to verify ad space purchases and proper execution of media plans. For ad exchanges and networks, the present approach can be used to confirm authenticity and accuracy of all bids. For publishers, the present approach can be used to ensure correct ad placements, inventory, and compliance with agreements. For ad tech platforms (e.g., DSPs, SSPs), the present approach can be used to verify accurate and untampered data processing and reporting and allow third party verification without access to the raw data. For auditors, the present approach can be used to verify compliance with industry regulations and standards.

### Gaming Example

As indicated above, in some embodiments, application platform and application environment may be representative of a gaming platform and gaming environment. For example, with in-game purchases, such approach can ensure all in-game transactions are properly recorded and be verifiable. At the platform level the present approach can ensure all financial transactions, including deposits and withdrawals, are accurate and secure. Gaming partners will have a method to verify they are getting proper payments as described in their agreements. Further, the system can verify that placement and outcomes of all wagers, both in sports style and skill-based deposits. In some embodiments, the present system can be used to provide a path for auditors to verify that the platform adheres to all relevant gaming regulations and standards, as well as be used for dispute resolution. In some embodiments, for content creators and streamers, the present system can be used to verify stats and earnings from streaming and other game related services. In some embodiments, the present approach can be used to store game playing statics and look for anomalies to help in fraud prevention. In some embodiments, the present approach can also benefit advertisers by providing a breakdown of those benefits have already been mentioned. Accordingly, by creating a verifiable and immutable representation of these activities, the present approach allows for auditing and verification that gamers behave properly, as well as identifying whether cheating or fraud occurred.

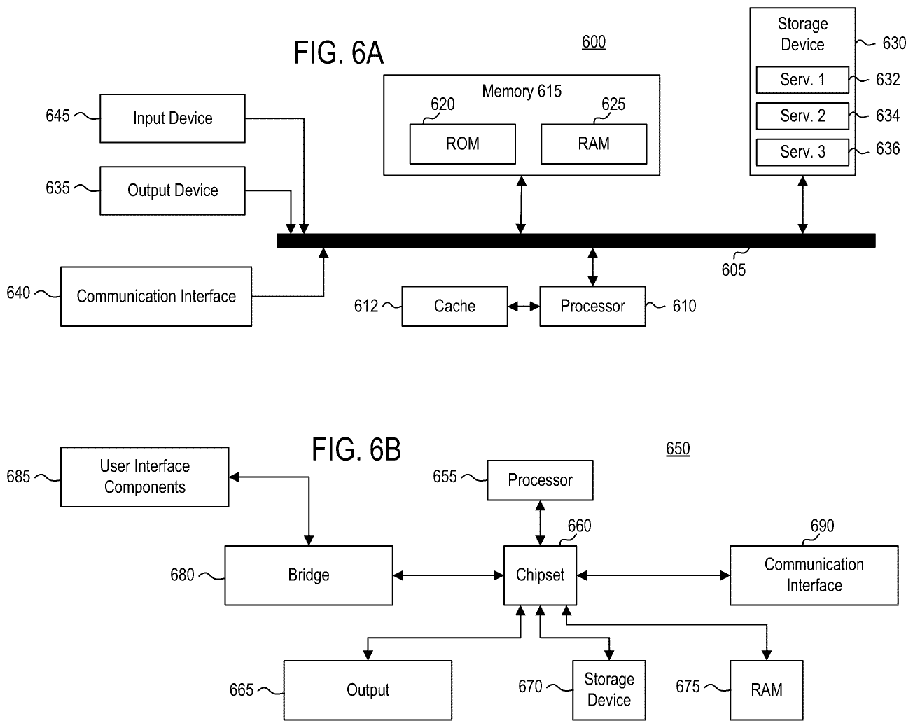

FIG. 6A illustrates an architecture of system bus computing system 600, according to example embodiments. One or more components of system 600 may be in electrical communication with each other using a bus 605. System 600 may include a processor (e.g., one or more CPUs, GPUs or other types of processors) 610 and a system bus 605 that couples various system components including the system memory 615, such as read only memory (ROM) 620 and random access memory (RAM) 625, to processor 610. System 600 can include a cache of high-speed memory connected directly with, in close proximity to, or integrated as part of processor 610. System 600 can copy data from memory 615 and/or storage device 630 to cache 612 for quick access by processor 610. In this way, cache 612 may provide a performance boost that avoids processor 610 delays while waiting for data. These and other modules can control or be configured to control processor 610 to perform various actions. Other system memory 615 may be available for use as well. Memory 615 may include multiple different types of memory with different performance characteristics. Processor 610 may be representative of a single processor or multiple processors. Processor 610 can include one or more of a general purpose processor or a hardware module or software module, such as service 1 632, service 2 634, and service 3 636 stored in storage device 630, configured to control processor 610, as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the system 600, an input device 645 can be any number of input mechanisms, such as a microphone for speech, a touch-sensitive screen for gesture or graphical input, keyboard, mouse, motion input, speech and so forth. An output device 635 (e.g., a display) can also be one or more of a number of output mechanisms known to those of skill in the art. In some instances, multimodal systems can enable a user to provide multiple types of input to communicate with system 600. Communication interface 640 can generally govern and manage the user input and system output. There is no restriction on operating on any particular hardware arrangement and therefore the basic features here may easily be substituted for improved hardware or firmware arrangements as they are developed.

Storage device 630 may be a non-volatile memory and can be a hard disk or other type of computer readable media that can store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 can include services 632, 634, and 636 for controlling the processor 610. Other hardware or software modules are contemplated. Storage device 630 can be connected to system bus 605. In one aspect, a hardware module that performs a particular function can include the software component stored in a computer-readable medium in connection with the necessary hardware components, such as processor 610, bus 605, output device 635 (e.g., a display), and so forth, to carry out the function.

FIG. 6B illustrates a computer system 650 having a chipset architecture, according to example embodiments. Computer system 650 may be an example of computer hardware, software, and firmware that can be used to implement the disclosed technology. System 650 can include one or more processors 655, representative of any number of physically and/or logically distinct resources capable of executing software, firmware, and hardware configured to perform identified computations. One or more processors 655 can communicate with a chipset 660 that can control input to and output from one or more processors 655. In this example, chipset 660 outputs information to output 665, such as a display, and can read and write information to storage device 670, which can include magnetic media, and solid-state media, for example. Chipset 660 can also read data from and write data to storage device 675 (e.g., RAM). A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 655 analyzing data stored in storage device 670 or 675. Further, the machine can receive inputs from a user through user interface components 685 and execute appropriate functions, such as browsing functions by interpreting these inputs using one or more processors 655.

It can be appreciated that example systems 600 and 650 can have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method comprising:
receiving, by an authorized computing device, indications of data actions taken by end users on a user platform, each data action being selected from a group comprising an edit action, a create action, or a delete action;
collecting, by the authorized computing device, the data actions to form a batch of data actions, the batch of data actions comprising data actions that have occurred within a range of time;
generating, by the authorized computing device, a Merkle tree corresponding to the batch of data actions, wherein each leaf of the Merkle tree is associated with a respective data action in the batch of data actions; and
publishing, by the authorized computing device, a root node of the Merkle tree to a smart contract associated with the user platform on a blockchain, wherein the root node of the Merkle tree is used to verify individual data actions in the batch of data actions.

2. The method of claim 1, further comprising:
broadcasting, by the authorized computing device, the batch of data actions to other authorized computing devices via an ad hoc peer-to-peer network.

3. The method of claim 1, wherein receiving, by the authorized computing device, the indications of the data actions taken by the end users on the user platform comprises:
receiving a first indication of a first data action taken by a first end user directly from an end user device associated with the first end user.

4. The method of claim 1, wherein receiving, by the authorized computing device, the indications of the data actions taken by the end users on the user platform comprises:
receiving a first indication of a first data action taken by a first end user from a second authorized computing device via an ad hoc peer-to-peer network.

5. The method of claim 4, further comprising:
verifying, by the authorized computing device, that the second authorized computing device is authorized by:
retrieving a list of authorized computing devices from the smart contract on the blockchain, and
comparing a signature of the second authorized computing device to signatures of authorized computing devices in the list of authorized computing devices.

6. The method of claim 1, wherein generating, by the authorized computing device, the Merkle tree corresponding to the batch of data actions comprises:
hashing each data action in the batch of data actions using a private key associated with the authorized computing device.

7. The method of claim 1, further comprising:
storing, by the authorized computing device, nodes of the Merkle tree in a database local to the authorized computing device; and
synchronizing, by the authorized computing device, the database local to the authorized computing device with additional databases local to other authorized computing devices.

8. A non-transitory computer readable medium comprising one or more sequences of instructions, which, when executed by a processor, causes an authorized computing device to perform operations comprising:
receiving, by the authorized computing device, indications of data actions taken end users on a social media platform, each data action being selected from a group comprising an edit action, a create action, or a delete action;
collecting, by the authorized computing device, the data actions to form a batch of data actions, the batch of data actions comprising data actions that have occurred within a range of time;
generating, by the authorized computing device, a Merkle tree corresponding to the batch of data actions, wherein each leaf of the Merkle tree is associated with a respective data action in the batch of data actions; and
publishing, by the authorized computing device, a root node of the Merkle tree to a smart contract associated with the social media platform on a blockchain, wherein the root node of the Merkle tree is used to verify individual data actions in the batch of data actions.

9. The non-transitory computer readable medium of claim 8, further comprising:
broadcasting, by the authorized computing device, the batch of data actions to other authorized computing devices via an ad hoc peer-to-peer network.

10. The non-transitory computer readable medium of claim 8, wherein receiving, by the authorized computing device, the indications of data actions taken end users on the social media platform comprises:
receiving a first indication of a first data action taken by a first end user directly from an end user device associated with the first end user.

11. The non-transitory computer readable medium of claim 8, wherein receiving, by the authorized computing device, the indications of data actions taken end users on the social media platform comprises:
receiving a first indication of a first data action taken by a first end user from a second authorized computing device via an ad hoc peer-to-peer network.

12. The non-transitory computer readable medium of claim 11, further comprising:
verifying, by the authorized computing device, that the second authorized computing device is authorized by:
retrieving a list of authorized computing devices from the smart contract on the blockchain, and
comparing a signature of the second authorized computing device to signatures of authorized computing devices in the list of authorized computing devices.

13. The non-transitory computer readable medium of claim 8, wherein generating, by the authorized computing device, the Merkle tree corresponding to the batch of data actions comprises:
hashing each data action in the batch of data actions using a private key associated with the authorized computing device.

14. The non-transitory computer readable medium of claim 8, further comprising:
storing, by the authorized computing device, nodes of the Merkle tree in a database local to the authorized computing device; and
synchronizing, by the authorized computing device, the database local to the authorized computing device with additional databases local to other authorized computing devices.

15. A system comprising:
an authorized computing device in communication with end user devices and other authorized computing devices, the authorized computing device comprising:
a processor; and
a memory having programming instructions stored thereon, which, when executed by the processor, causes the system to perform operations comprising:
receiving, by the authorized computing device, indications of data actions taken end users on a social media platform, each data action being selected from a group comprising an edit action, a create action, or a delete action;
collecting, by the authorized computing device, the data actions to form a batch of data actions, the batch of data actions comprising data actions that have occurred within a range of time;
generating, by the authorized computing device, a Merkle tree corresponding to the batch of data actions, wherein each leaf of the Merkle tree is associated with a respective data action in the batch of data actions; and
publishing, by the authorized computing device, a root node of the Merkle tree to a smart contract associated with the social media platform on a blockchain, wherein the root node of the Merkle tree is used to verify individual data actions in the batch of data actions.

16. The system of claim 15, further comprising:
broadcasting, by the authorized computing device, the batch of data actions to the other authorized computing devices via an ad hoc peer-to-peer network.

17. The system of claim 15, wherein receiving, by the authorized computing device, the indications of data actions taken end users on the social media platform comprises:
receiving a first indication of a first data action taken by a first end user directly from an end user device associated with the first end user.

18. The system of claim 15, wherein receiving, by the authorized computing device, the indications of data actions taken end users on the social media platform comprises:
receiving a first indication of a first data action taken by a first end user from a second authorized computing device via an ad hoc peer-to-peer network.

19. The system of claim 18, further comprising:
verifying, by the authorized computing device, that the second authorized computing device is authorized by:
retrieving a list of authorized computing devices from the smart contract on the blockchain, and
comparing a signature of the second authorized computing device to signatures of authorized computing devices in the list of authorized computing devices.

20. The system of claim 15, further comprising:
storing, by the authorized computing device, nodes of the Merkle tree in a database local to the authorized computing device; and
synchronizing, by the authorized computing device, the database local to the authorized computing device with additional databases local to the other authorized computing devices.
